(19) United States
(12) Patent Application Publication
(10) Pub. No.: US 2026/0348726 A1
(43) Pub. Date: Nov. 5, 2026

(54) METHOD AND LASER SYSTEM FOR COMPENSATING FOR MALADJUSTMENTS

(71) Applicant: TRUMPF Lasersystems for Semiconductor Manufacturing SE, Ditzingen (DE)

(72) Inventors: Kai Carstens, Kirchheim (DE); Christian Weinzetl, Mainz (DE); Clemens Kieninger, Stuttgart (DE)

(21) Appl. No.: 19/705,834

(22) Filed: Jun. 12, 2026

Related U.S. Application Data
(63) Continuation of application No. PCT/EP2024/083784, filed on Nov. 27, 2024.

(30) Foreign Application Priority Data
Dec. 15, 2023 (DE) 10 2023 135 411.6

(51) Int. Cl. G01B 11/27

(52) U.S. Cl. CPC G01B 11/272

(57) ABSTRACT

A method for operating a laser system includes continuously monitoring maladjustments during normal operation of the laser system and, upon detecting a maladjustment, determining at least one operating parameter of the laser system. A change to the at least one operating parameter has an effect counter to the maladjustment. The method further includes adjusting the at least one operating parameter in order to compensate for the maladjustment.

### CROSS REFERENCE TO RELATED APPLICATIONS

This application is a continuation of International Application No. PCT/EP2024/083784 (WO 2025/124902 A1), filed on Nov. 27, 2024, and claims benefit to German Patent Application No. DE 10 2023 135 411.6, filed on Dec. 15, 2023. The aforementioned applications are hereby incorporated by reference herein.

### FIELD

Embodiments of the present invention relate to a method for operating a laser system and to a correspondingly configured laser system.

### BACKGROUND

Nowadays, laser systems are used for many different applications. In this context, increasingly higher demands are being made, for example with regard to performance, precision and reliability. At the same time, however, current laser systems, e.g. for industrial applications, may exhibit considerable complexity. This can promote the occurrence of situations in which such a laser system does not operate precisely in accordance with a target specification, that is to say for example is misaligned or maladjusted or incorrectly adjusted. In addition, there may be degradation of individual components, e.g. on account of changing ambient conditions, or mechanical misalignment of passive optical elements, e.g. on account of vibrations. To avoid this by conventional means is either not practicable or could lead to disproportionately high costs, and therefore manual maintenance measures are often required or carried out instead in corresponding situations. For this purpose, the laser system may have to be completely or partially shut down or set to a maintenance or adjustment mode, and this may entail effort and costs and lead to reduced overall efficiency or productivity. Improvements would therefore be desirable here.

### SUMMARY

Embodiments of the present invention provide a method for operating a laser system. The method includes continuously monitoring maladjustments during normal operation of the laser system and, upon detecting a maladjustment, determining at least one operating parameter of the laser system. A change to the at least one operating parameter has an effect counter to the maladjustment. The method further includes adjusting the at least one operating parameter in order to compensate for the maladjustment.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of a laser system with automatic maladjustment compensation according to some embodiments;

FIG. 2 is a schematic diagram illustrating the influences of various operating parameters of the laser system on a laser beam alignment according to some embodiments;

FIG. 3 is a schematic diagram illustrating a range in which an incorrect laser beam alignment can be compensated, according to some embodiments; and

FIG. 4 is a flowchart for a method for operating a corresponding laser system according to some embodiments.

### DETAILED DESCRIPTION

Embodiments of the present invention can enable particularly robust operation and particularly high accuracy of a laser system in a particularly simple and efficient manner.

The method according to the embodiments of the invention can be used for or during the operation of a laser system or a laser installation. The method comprises a plurality of method steps which can be carried out automatically during normal operation of the respective laser system. Here, normal operation means operation of the laser system in regular, productive use, that is to say for example not maintenance operation or test operation or setting or adjustment operation. In normal operation, the laser system can thus be operated as intended and, for example, at full power and without any other restrictions.

In the method according to embodiments of the invention, the laser system is continuously monitored for incorrect adjustments or maladjustments. These can be deviations from a predefined target or desired behavior of the laser system, such as, for example, incorrect alignment of a generated or emitted laser beam, such that the latter is not incident on a predetermined target point, for example. This can be detected by means of a corresponding monitoring camera, for example, and/or by some other sensor system. Here, monitoring for maladjustments can be carried out repeatedly at regular intervals at a predetermined frequency or continuously, for example, and/or can be triggered in each case by one or more predefined trigger events, for example.

Furthermore, in the method according to embodiments of the invention, if a maladjustment is detected, at least one operating parameter of the laser system is determined, a change to which has an effect counter to the maladjustment, i.e. a direction of the corresponding deviation from the desired behavior. In the present case, changing the operating parameter or an operating parameter means changing the actual value and/or the setpoint value for this operating parameter. By way of example, a list or a table or a characteristic map or the like can be specified, from which the automatically changeable, that is to say adaptable, operating parameters and corresponding effects or actions can be determined or read out.

In a further method step of the method according to embodiments of the invention, the at least one operating parameter determined is then automatically adapted, i.e. changed, in order to completely or at least partially balance out, i.e. compensate for, the detected maladjustment. The at least one operating parameter can thus be used here as a manipulated variable or control variable in order to achieve or re-establish the predetermined target or desired behavior of the laser system in whole or in part. This can lead potentially to the adapted value of the at least one operating parameter then ultimately deviating from a nominal setpoint value of this operating parameter in what is overall the optimally adjusted state of the laser system, that is to say it may be set differently therefrom.

The adaptation of the at least one operating parameter can mean or comprise a one-time or individual adaptation or ongoing closed-loop control. In the latter case, the laser system can have, for example, a corresponding controller, such as a PID or fuzzy controller, for the at least one operating parameter or per operating parameter.

Since, in the method according to embodiments of the invention, the operating parameter that can be determined and used to compensate for the maladjustment is one which can be automatically adapted during ongoing normal operation of the laser system, the compensation or elimination of the maladjustment can be carried out non-invasively. Thus, the laser system does not have to be switched off and manual maintenance or readjustment is also not necessary. This ultimately makes it possible to achieve particularly robust or reliable ongoing, that is to say sustained, operation of the laser system with a particularly high efficiency, that is to say a particularly high proportion of productive or useful time. This in turn can reduce operating or manufacturing costs associated with the laser system in comparison with conventional approaches.

Embodiments of the present invention are based on the insight that current laser systems, with their considerable complexity, often have a multiplicity of different adjustable operating parameters which can have a direct or indirect influence on various properties or an operating state of the laser system, and thus corresponding, at least indirect, control is possible. The detected maladjustment can thus be effectively eliminated, e.g. even if the actual cause thereof is not the ultimately adapted operating parameter. Embodiments of the present invention can therefore be used to enable effective, in particular uninterrupted, operation or continued operation during or after a maladjustment of the laser system, e.g. even if the elimination of the actual cause of the maladjustment is not readily possible or, for example, not without interrupting the operation of the laser system, but for example only in the context of a maintenance or repair intervention. This can moreover be made possible or achieved particularly simply, with particularly little effort and in a particularly cost-efficient manner since corresponding operating parameters which have an influence on the behavior of the laser system may often already be automatically adjustable in principle in conventional laser systems, or such automatic adjustability can be achieved with comparatively little effort. This may be possible, for example, purely on the basis of software, that is to say by means of a corresponding open-loop or closed-loop control program. However, it is likewise possible, for example, for additionally necessary hardware, such as an additional electronic controller or a valve or a heating or cooling device, to be installed in the laser system or retrofitted in an existing laser system, often in a comparatively simple and low-cost manner, e.g. in comparison with a design that is not susceptible to maladjustments, including corresponding monitoring and control of the ambient conditions, or use of more precise and more robust servomotors for optical elements or the like.

Embodiments of the present invention also relate to a laser system or a laser installation having at least one laser source, that is to say at least one light or radiation source for laser light, a conditioning or influencing device for conditioning or influencing a laser beam generated by the laser source, and an optical unit. In this case, the influencing device and the optical unit are connected downstream of the laser source in an intended beam propagation direction of the laser beam within the laser system. In the present sense, conditioning or influencing of the laser beam can mean or comprise, for example, the amplification or modulation thereof or wavelength conversion or chopping into individual laser pulses and/or the like. The conditioning or influencing device can thus be, for example, an amplifier and/or a modulator and/or a wavelength converter and/or a chopper or can comprise such a device. Furthermore, the laser system according to embodiments of the invention has a monitoring device for automatically detecting maladjustments of the laser system, in particular in respect of the alignment and/or predetermined properties of the laser beam, and a control device for open-loop and/or closed-loop control of at least one operating parameter of the laser system. In this case, the laser system according to embodiments of the invention is configured to carry out the method according to embodiments of the invention, in particular automatically or partially automatically. The laser system according to embodiments of the invention can thus be the laser system mentioned in connection with the method according to embodiments of the invention or can correspond to said laser system. Likewise, the laser system according to embodiments of the invention can have further components or functions not explicitly mentioned here, such as an electrical power supply, an RF power source or an RF power supply (RF: radio frequency), a cooling system, a gas system and/or the like. These components can form additional internal devices of the laser system or, for example, at least in some cases can be a constituent part of the influencing device.

In one possible embodiment of the present invention, the laser system is configured to detect, as maladjustments, an unintentional change in the alignment of the laser beam and/or the output caustic of the laser system and/or a laser power. A changed alignment of the laser beam, that is to say an incorrect alignment, can mean, for example, a displacement or tilt of a corresponding optical axis of the laser system. Such a changed alignment can be determined in particular at or after an output of a drive or excitation laser or of an amplifier or preamplifier of the laser system. Likewise, the output caustic can be determined in particular downstream of a preamplifier or main amplifier in the beam propagation direction, in particular downstream of the amplifier of the laser system last traversed by the laser beam in the beam propagation direction. The laser power can likewise be determined after one or after the last amplifier of the laser system. Likewise, the laser power can be determined, for example, at a plurality of points, in particular after and/or before a plurality of amplifiers or all amplifiers of the laser system. The latter can enable more accurate location of the maladjustment and possibly a more appropriate response or measure, that is to say an appropriately adapted selection and/or adaptation of the at least one operating parameter. In this way, it may be possible to enable or achieve compensation of the maladjustment by means of a minimal adaptation. According to one insight on which embodiments of the present invention is based, the maladjustments described here can typically be effectively influenced by one or more suitably selected operating parameters and are thus particularly well suited for the application of the embodiments of the present invention.

In a further possible embodiment of the present invention, the influencing device comprises at least one amplifier for amplifying the laser beam, that is to say for instance its intensity or power. The laser system is then configured to determine and adapt at least one operating parameter of the amplifier as the at least one operating parameter. In particular, just one or more operating parameters of the amplifier or devices feeding or supplying the latter can be used to compensate for the respective maladjustment. It has been found that the amplifier or an amplifier can offer a variety of possibilities for effectively influencing the laser beam and thus for compensating for maladjustments. At the same time, by using one or more operating parameters of the amplifier, it is possible to compensate for the maladjustment without adjusting the optical unit or disturbing the laser source, that is to say the actual generation of the laser light. This may be particularly advantageous since the optical unit can often be adjusted only with relatively low precision or a precise adjustment possibility for the optical unit can lead to very high costs, and a change in operating parameters of the laser source is often not practicable.

In a further possible embodiment of the present invention, the influencing device has a plurality of amplifiers, that is to say, for example, a plurality of amplifiers or amplifier stages connected in series for amplifying the laser beam generated by the laser source. The laser system is then configured to automatically divide the adaptation of the at least one operating parameter between the plurality of amplifiers. In this case, for example, an overall scope of the adaptation of a specific operating parameter can be divided between a plurality of amplifiers and/or different operating parameters can be adapted for different amplifiers. The division can be uniform or non-uniform. If, in the case of uniform division, a specific operating parameter is to be changed by a total of 10% for example, the same operating parameter can be changed by 5% in a first amplifier and likewise by 5% in a second amplifier. If two different operating parameters are to be adapted, then, for example, the first operating parameter can be changed, i.e. adapted, in or at a first amplifier and the second operating parameter can be changed, i.e. adapted, in or at a second amplifier. The embodiment of the present invention described here can firstly prevent the behavior of an individual amplifier from changing too much or by more than necessary. As a result, robust functioning of the amplifiers can be maintained particularly reliably and the occurrence of unexpected side effects of a major change in the operating parameters of an individual amplifier can be avoided. On the other hand, it is possible in this way to perform particularly extensive adaptations or to compensate for particularly large maladjustments overall. Thus, for example, the maximum adaptation or adjustment range for a specific operating parameter in an individual amplifier can be limited. By utilizing the possible adaptation or adjustment ranges of a plurality of amplifiers for the same and/or a plurality of different operating parameters, correspondingly greater effects can then be achieved.

According to a further possible embodiment of the present invention, the at least one operating parameter is or controls a property of the laser system that differs from a mechanical position or angular position, that is to say the alignment of an optical element of the laser system that is impinged on, that is to say irradiated or penetrated, by the laser beam. In the present sense, an optical element can be an, in particular passive, component of the optical unit, that is to say for instance a mirror or a lens or a prism. In other words, it is therefore not a position or alignment of an optical element that is changed here by adapting or changing the at least one operating parameter. Rather, the at least one operating parameter can be, for example, an electrical operating parameter and/or a thermal operating parameter and/or a material parameter. By virtue of the embodiment of the present invention described here, the laser system does not have to have a typically very complex or cost-intensive automatic precise setting possibility for the optical elements and can nevertheless enable automatic compensation of maladjustments. Robust and reliable operation of the laser system can thus be made possible in a particularly simple and low-cost manner. Moreover, it may thereby be possible to enable or support a particularly simple and compact construction of the laser system.

In a further possible embodiment of the present invention, the laser system is configured to determine, that is to say select, the at least one operating parameter from a predetermined list of operating parameters. This predetermined list comprises at least one gas composition, a gas exchange waiting time, a gas pressure, a gas volume flow, a gas temperature, a coolant temperature, a coolant volume flow, an RF power, an amplifier off time, and a pre-pulse laser power. The gas composition, the gas exchange waiting time, the gas volume flow, the gas temperature and the gas pressure can apply to volumes within the laser system through which the laser beam or laser light passes. There, for example, a refractive index or a gain factor or contamination or the like can be influenced by these operating parameters in order to influence the laser beam. Whether and possibly which of these operating parameters can be adapted in a specific laser system can depend on its specific design. Thus, the gas pressure, e.g. in a laser system with continuous gas flow, can be adapted in a correspondingly continuous manner. In other laser systems, the gas pressure can optionally be adapted only or preferably during a gas exchange, for example in combination with a gas analysis.

To adapt the gas composition, i.e. a gas mixture, it is possible, for example, to introduce additional helium into the corresponding volume, or the like. Adapting the gas exchange waiting time can, for example, enable the exploitation of contamination and/or diffusion effects. For adapting, for example, the gas composition and/or the gas pressure and/or the gas temperature, it is possible to use, for example, a molecular sieve, composed of a zeolite material for instance, arranged in or on the respective gas volume. This can be fitted in particular by means of a controllable heating and/or cooling device. It is thereby possible, for example, to automatically control an adsorption rate or a release of previously adsorbed molecules. The RF power can be, for example, an RF input power or RF supply power of the amplifier mentioned elsewhere and/or a reflected power. This can be adapted, for example, by controlling an adaptation network between an RF power source and the device supplied with the RF power, in particular the amplifier. Likewise, adaptation can be effected or implemented here, for example, by corresponding control of a duty cycle of the RF power source, in particular in the case of a non-continuously pumped amplifier.

Overall, the operating parameters mentioned here offer various comparatively easy-to-implement or easy-to-exploit and effective influencing possibilities for compensating for maladjustments. The adaptation of at least some of the aforementioned operating parameters can be possible purely on the basis of software and can thus be readily retrofitted even in existing laser systems. Any hardware or components that may be required to adapt some of the aforementioned operating parameters in comparison with conventional laser systems can be integratable at comparatively low cost and easily into existing laser system designs.

In a further possible embodiment of the present invention, the laser system is configured to automatically limit the adaptation of the at least one operating parameter such that the adaptation does not result in a predetermined lower threshold value for a laser output power of the laser system being undershot. In other words, the laser system can thus be configured to define or implement the at least one operating parameter on the basis of or taking into account a power of the laser beam or laser light output by the laser system. The laser output power considered here can be, for example, the power of the laser beam at or immediately after the aforementioned, in particular the last, amplifier of the laser system or in a target zone into which the laser beam generated by the laser system is directed as intended. Here, the laser system can likewise be configured to control or limit the adaptation of the at least one operating parameter in such a way that the laser power is kept within a predetermined range. In other words, therefore, the laser system can then take into account not only a predetermined minimum power to be observed but also a predetermined maximum laser-beam power to be observed. Since the adaptation of various operating parameters can have an influence on the laser output power, it may therefore be necessary to limit the adaptation or the adjustment range of an operating parameter accordingly.

Should a greater adaptation or a greater adjustment range of this operating parameter be nominally necessary to compensate for a certain maladjustment, the laser system can be configured to additionally or alternatively determine and adapt at least one other operating parameter which has a smaller or no influence or an opposite influence on the laser output power. The maximum extent of the adaptation and/or the selection of the operating parameter(s) to be adapted can thus be limited here by a predetermined minimum gain to be observed of a laser-system amplifier or the laser-system amplifier mentioned elsewhere. The predetermined threshold value can then therefore be effectively specified for the minimum gain of the amplifier, for example, or can be dependent on it, also taking into account or including losses occurring after the amplifier, for example. By taking into account the laser output power when compensating for a maladjustment in the embodiment of the present invention described here, it is possible to ensure that the laser system can always perform its intended task. For this purpose, it is possible, for example, to prioritize the attainment of at least the predetermined minimum laser output power or the corresponding minimum gain over the complete compensation of a detected maladjustment. Overall, the embodiment of the present invention described here can likewise be of benefit for particularly robust and reliable operation of the laser system.

In a further possible embodiment of the present invention, the laser system is configured to adapt a plurality of operating parameters of the laser system in combination with one another in order to compensate for the respective maladjustment. In this case, the laser system can be configured in particular to carry this out depending on the magnitude or severity of the respective maladjustment detected. This can mean, for example, that if or only if the maladjustment exceeds a predetermined magnitude or severity or if an individual operating parameter would have to be changed by more than a predetermined absolute or relative value or amount to completely compensate for the maladjustment is a plurality of operating parameters determined and adapted to compensate for this maladjustment. As a result, relatively small maladjustments can possibly be compensated more easily, while relatively large maladjustments can be compensated without excessively changing an individual operating parameter, as a result of which unwanted side effects can possibly be avoided or reduced. In addition, the embodiment of the present invention described here can also enable automatic compensation of maladjustments which it would not be possible to compensate for completely by adapting just one single operating parameter. Thus, ultimately, particularly robust, reliable and precise operation of the laser system, possibly even over the particularly long term, can be achieved or ensured.

In a further possible embodiment of the present invention, the laser system is configured to adapt the at least one operating parameter by means of closed-loop, in particular predictive closed-loop, control based on a predetermined model. In other words, it is possible here, for example, to use a model which can model or simulate the laser system or its behavior, that is to say in particular the effects of an adaptation or change of one or more operating parameters of the laser system. Thus, the at least one operating parameter to be adapted and/or an extent or degree of adaptation of the at least one operating parameter necessary to compensate for the detected maladjustment can then be determined—optionally in a plurality of differently parameterized simulations or model passes—before an operating parameter of the laser system is actually adapted. In this case, the model may optionally also use or take into account a respectively current operating state of the laser system as an input or boundary condition. The embodiment of the present invention described here can enable particularly accurate and reliable adaptation of the at least one operating parameter and thus enable or support particularly robust, correct and low-interruption operation of the laser system.

As the basis or input for the model, it is possible, for example, to use one or more sensitivity curves for the laser system, which can indicate effects of a change in one or more operating parameters, in particular depending on the magnitude of the respective change. Such sensitivity curves can be predetermined, determined during operation or adapted or updated on the basis of data recorded during operation, for example. Corresponding data, that is to say for example measurement or sensor data recorded during operation, from which the sensitivity curves can be generated, can be obtained during the operation of a plurality of laser systems, for example. In this way, corresponding data can be obtained particularly quickly and easily for a multiplicity of different situations or conditions, thus enabling the corresponding sensitivity curves to be correspondingly robust and to cover a particularly large state or parameter space. It may be possible to obtain corresponding data without special measurement or test operation of the laser system or laser systems since in practical use variations or fluctuations of various operating parameters, the operating state and the conditions under which the laser system or laser systems are operated almost inevitably occur in any case. In other words, the corresponding data can therefore be obtained on the basis of natural or unavoidable variations in practical use or productive operation of the laser system or laser systems.

In one possible embodiment of the present invention, the model is based on operating data recorded during previous operation, that is to say for example measurement or sensor data, exclusively of the respective laser system itself. In other words, it is possible to use for the model, that is to say for modeling or simulating the adaptations of one or more operating parameters, only data or sensitivity curves of exactly the laser system in which a detected maladjustment is to be compensated. It is therefore possible in each case to use an installation-or system-specific or system-tailored model for the respective laser system. It is thereby possible to automatically take into account individual properties or special features of the respective laser system, which are not necessarily known in detail but can determine or influence the behavior of the respective laser system. This in turn allows a particularly high accuracy of the model and thus particularly precise determination of an adaptation of one or more operating parameters which is necessary to compensate for the respective maladjustment. To this end, the laser system can be equipped with corresponding sensors or data acquisition devices in order to acquire current values or a time characteristic of one or more operating parameters of the respective laser system as well as properties or behaviors or operating states of the laser system which correspond thereto as a basis, or parameters of the model and/or sensitivity curves on which said model is based. For example, these can be sensors or data acquisition devices for the maladjustments and operating parameters mentioned elsewhere.

In a further possible embodiment of the present invention, the laser system additionally has an adjusting device for adjusting the alignment of at least one, in particular passive, element of the optical unit. By means of the or a respective adjusting device, it is thus possible to automatically move one or more of the optical elements mentioned elsewhere, that is to say for example mirrors, lenses, prisms or the like. This may mean or comprise, for example, translation, rotation, tilting and/or the like. The adjusting device can comprise, for example, a servomotor, in particular an electric servomotor, a coil or an electromagnet for electromagnetic adjustment, a linear drive and/or the like. In the embodiment of the present invention described here, the laser system is configured, if and only if a detected maladjustment cannot be completely compensated for by maximum adaptation, that is to say by full utilization of the maximum range of change or adjustment of the at least one operating parameter, to compensate for the maladjustment—at least as far as possible—additionally or alternatively by means of the adjusting device. Here, therefore, the adjusting device or the possibility of compensating for the maladjustment by adjusting or changing the alignment of at least one element of the optical unit can serve or be implemented as a fallback solution. This can be used, for example, if compensation of the maladjustment by means of corresponding settings or adaptations of one or more operating parameters of the at least one amplifier mentioned elsewhere would result in a predetermined minimum gain then no longer being achieved, for example. The embodiment of the present invention described here makes it possible, on the one hand, to enable particularly accurate and flexible compensation for correspondingly smaller maladjustments. On the other hand, however, it is ultimately also possible to compensate for particularly large maladjustments, at least if these manifest themselves in an incorrect alignment or propagation direction of the laser beam.

Identical or functionally identical elements are provided with the same reference signs in the figures.

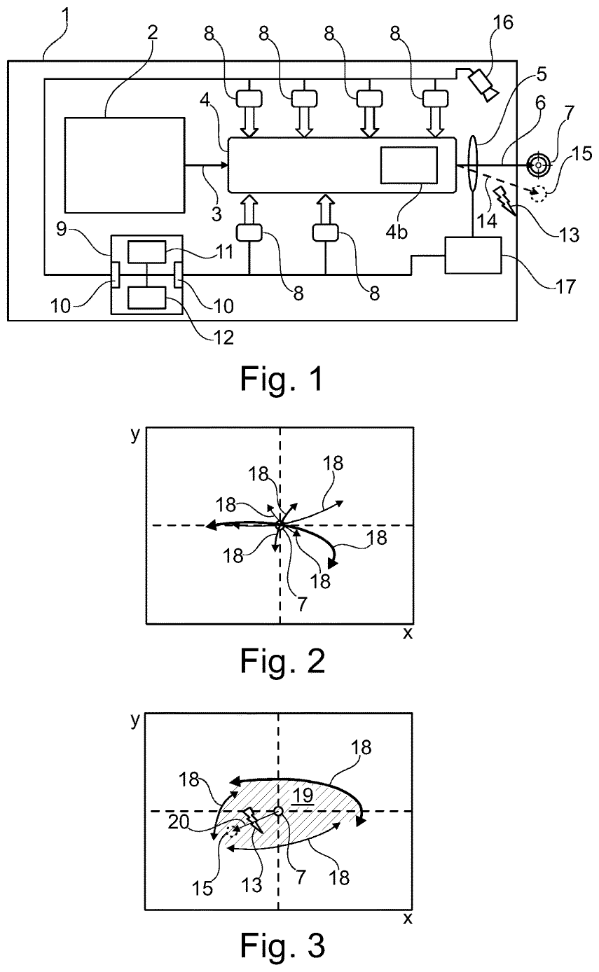

FIG. 1 shows a schematic and simplified illustration of a laser system 1. Here, the laser system 1 comprises a laser source 2, which can generate one or more laser beams 3. Here, the laser source 2 can be a single radiation or light source or can comprise a plurality of radiation or light sources. Likewise, the laser source 2 can comprise one or more preamplifiers.

The generated laser beam 3 can be amplified within the laser system 1. For this purpose, the laser system 1 has at least one amplifier 4b. The amplifier 4b can be a single amplifier or, in this case, can schematically represent a plurality of amplifiers or amplifier stages, e.g. connected in series.

Furthermore, the laser system 1 has an optical unit, which is indicated here by way of example by a passive optical element 5 arranged downstream of the amplifier 4b. The optical unit can likewise have further optical elements 5, which can likewise be arranged for example between the laser source 2 and the amplifier 4b. The optical unit can comprise, for example, one or more lenses and/or one or more mirrors or the like as optical elements 5. It is also possible for further active optical elements to be included, such as an acousto-optical and/or electro-optical modulator.

The laser system 1 can be provided for EUV light generation, for example. In this case, laser light can be directed at a corresponding target or reaction material, for instance a tin drop, which can subsequently release EUV radiation. For efficient and smooth functioning of this process, accurate irradiation of the reaction material with the laser light is required. Therefore, the laser system 1 is typically adjusted in an appropriate manner at its intended use location. In the case of correct adjustment, the laser beam 3 amplified by means of the amplifier 4b can be output by the laser system 1 as an appropriately adjusted laser beam 6 and then impinge on a predetermined desired target 7, that is to say for example the reaction material mentioned or a corresponding spatial region.

Amplifying the laser beam 3 with the highest possible efficiency and amplification power in a practical wavelength range can represent a complex task. Therefore, the laser system 1 can have or use a correspondingly large number of different operating parameters 8, indicated schematically here. By way of example, a plurality of operating parameters which relate in particular to the amplifier 4b are indicated here. These may be, for example, adjustable properties of a gas supply, an RF or high-frequency power supply, a cooling device, a heatable and/or coolable molecular sieve and/or the like. For monitoring and open-loop or closed-loop control of these operating parameters 8 or of actual and setpoint values of the operating parameters 8, the laser system 1 also has a corresponding control device 9 here. The control device 9 can be coupled, e.g. via corresponding interfaces 10, to devices and/or sensors assigned to the operating parameters 8. To carry out the measures or control sequences described here, the control device 9 can have corresponding electronics and/or circuit logic, which is schematically indicated here by a processor 11 and a computer-readable data memory 12 coupled thereto. The processor 11 can be, for example, a microprocessor or microchip or microcontroller or the like. By way of example, a corresponding operating or computer program and, if appropriate, a predetermined model for the laser system 1 and/or other data can be stored in the data memory 12, and these can then be executed or processed by means of the processor 11.

In practice, unwanted situations, in which deviations from the optimum adjustment of the respective system occur, may ultimately arise repeatedly when operating complex systems such as the laser system 1. This can have different causes, such as, for example, a change in the ambient conditions, thermal effects, which can lead, for example, to a changed thermal expansion of components of the laser system 1, degradation or a defect of individual components, a mechanical adjustment, for example of the at least one passive optical element 5, an unintentional change or incorrect setting of one of the operating parameters 8 and/or the like. As a result, therefore, a maladjustment 13, indicated schematically here, can then occur. Such a maladjustment 13 can then result, for example, in a correspondingly maladjusted laser beam 14 being produced instead of the adjusted laser beam 6, said maladjusted laser beam being directed at or impinging on not the desired target 7 but at/on a faulty or unwanted incorrect target 15 that is then different therefrom.

Such maladjustments 13 can in principle be eliminated or corrected by switching off the laser system 1 or setting it to a special adjustment operating mode and then carrying out manual adjustment. However, since this is complicated and may require an unwanted interruption in the productive operation of the laser system 1, the laser system 1 is configured here to automatically compensate for corresponding maladjustments 13. Here, this is effected by automatic adaptation of settings or operating conditions of the laser system 1, that is to say in particular of the adjustable operating parameters 8 of the optical amplifier 4b, optionally taking into account predetermined requirements or boundary conditions.

In order to implement such an automatic adaptation, the laser system 1 here also has a monitoring device 16 for automatically detecting maladjustments 13. In addition, the control device 9 is configured to determine one or more of the operating parameters 8, which can be adapted, that is to say changed in terms of their value, to compensate for the respectively detected maladjustment 13, and then to automatically adapt the corresponding at least one operating parameter 8 accordingly. In addition, the laser system 1 here also has an automatically controllable adjusting device 17 for, in particular mechanical or geometric, adjustment of the at least one optical element 5. Here, this adjusting device 17 can likewise be controllable automatically by the control device 9.

Since it is not necessarily readily apparent in what ranges the operating parameters 8 are in each case adjustable without impeding or excessively impeding the functionality or task of the laser system 1, and what specific effects changes in one or more of the operating parameters 8 have on the properties or the operation of the laser system 1, that is to say for example on the laser beam alignment, a corresponding sensitivity analysis can first be carried out. This can be implemented in a corresponding measurement or test mode or on the basis of fluctuations or variations in the operating parameters 8 that occur during the ongoing productive operation of the laser system 1. For illustration purposes, FIG. 2 shows a schematic diagram. This illustrates a plane defined by spatial x- and y-directions, which can be perpendicular to the adjusted laser beam 6, for example in the region of the desired target 7. Here, the desired target 7 is accordingly located in the center of the plane illustrated. Various sensitivity curves 18 are illustrated here by way of example, each of which specifies for one of the settable operating parameters 8 how changing it affects the laser beam alignment. It can be seen that adaptations of various operating parameters 8 can lead to different displacements in the x-direction and/or in the y-direction.

In practice, a plurality of the operating parameters 8 can be adapted, that is to say adjusted, simultaneously or in combination with one another. As schematically illustrated in FIG. 3, this results in a corresponding possible adjustment or compensation range 19. This compensation range 19 specifies the surface area or the spatial region in which maladjustments 13 that are evident in a misalignment can be compensated for by automatic adaptation of one or more of the operating parameters 8. For further illustration, a displacement 20 accompanying the maladjustment 13 is illustrated here, which has the effect that the corresponding maladjusted laser beam 14 then no longer impinges on the desired target 7 but on the corresponding incorrect target 15. Here, the incorrect target 15 lies within the compensation range 19. This means that the corresponding maladjustment 13 can be compensated for by suitably adapting one or more of the operating parameters 8 in accordance with the corresponding sensitivity curves 18, ensuring that the desired target 7 is then hit again.

If, in the case of a larger maladjustment 13, the incorrect target 15 were outside the compensation range 19, the incorrect target 15 could possibly be shifted closer to the desired target 7 by corresponding adaptation of one or more of the operating parameters 8, without ultimately reaching said target completely.

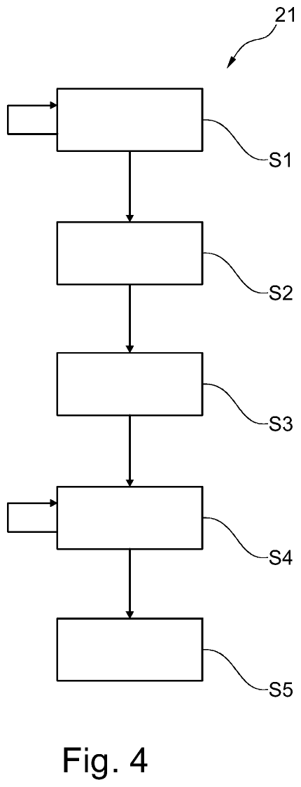

For further illustration, FIG. 4 shows an illustrative schematic flowchart 21 for a method for operating the laser system 1. In this chart, in a method step S1, data that specify behaviors and operating states of the laser system 1 at different values of the operating parameters 8 can first be recorded or collected. During this process, it is also possible, for example, for the respectively current ambient conditions and/or further variables to be acquired. Depending on requirements, the corresponding data can be acquired only from the laser system 1 itself or from one or more different such laser systems 1. As indicated here by a looping path, this method step S1 can be carried out repeatedly or continuously.

On the basis of the data collected in method step S1, the sensitivity curves 18 or the corresponding model of the laser system 1 can be generated in a method step S2.

The possible compensation range 19 can then be determined in a method step S3.

During ongoing normal or productive operation of the laser system 1, monitoring for maladjustments 13 can then be carried out continuously or repeatedly at regular intervals in a method step S4. For this purpose, the desired target 7, for example, and a surrounding region, for example a region at least corresponding to the compensation range 19, can be observed by means of the monitoring device 16. For this purpose, the monitoring device 16 can be or comprise a camera, for example. Likewise, for this purpose, for example, a portion of the laser light can be directed to the monitoring device 16 or to the corresponding camera after leaving the amplifier, in particular after passing through the optical unit or the at least one optical element 5, in order to detect maladjustments 13. Monitoring for further types of maladjustments 13 can likewise be carried out by means of the monitoring device 16. For this purpose, the monitoring device 16 can monitor, for example, a power of the laser light at or after the output of the amplifier 4b by means of a corresponding sensor.

In response to a detected maladjustment 13, it is then possible, in a method step S5, by means of the control device 9, to determine which of the operating parameters 8 should be adapted in what manner or to what extent in order to compensate for the detected maladjustment 13, and the corresponding adaptation can be carried out, optionally automatically. If it is recognized here that complete compensation of the maladjustment 13 by adapting one or more of the operating parameters 8 is not possible, then the adjusting device 17 can additionally or alternatively be automatically activated to compensate for the maladjustment 13. In the case of a combination of adaptation of at least one of the operating parameters 8 and adjustment of the at least one optical element 5 by means of the adjusting device 17, it may be possible to minimize the latter. It is thereby possible, e.g. when using an anisotropic optical element 5 or an optical element that acts in a manner dependent on a light incidence direction, to avoid or minimize corresponding unwanted influencing of the laser light.

Automatic adaptation of the operating parameters 8 and/or of the adjusting device 17 can be carried out continuously or as ongoing closed-loop control during operation of the laser system 1, for example. For this purpose, the control device 9 can therefore form or implement a corresponding controller, or the laser system 1 can have at least one corresponding controller.

According to the method proposed here, one or more manipulated variables or control variables of the laser system 1, in particular at the amplifier 4b, can be automatically adapted in order to compensate for, that is to say correct, maladjustments 13 at or after the output of the amplifier 4b without significantly influencing other important output variables in the process. The latter can be achieved in that, in dependence on corresponding predetermined requirements or boundary conditions, the compensation range 19 is correspondingly limited for example. In the automatic compensation of the maladjustments 13 proposed here, the respective cause thereof may or may not be eliminated, and this may depend on the respective cause and the control or setting possibilities of the respective laser system 1.

Overall, the examples described show how laser beam alignment control can be achieved and applied on a laser installation, e.g. by way of amplifier settings.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Laser system
2 Laser source
3 Laser beam
4 Influencing device
4b Amplifier
5 Optical element
6 Adjusted laser beam
7 Desired target
8 Operating parameters
9 Control device
10 Interface
11 Processor
12 Data memory
13 Maladjustment
14 Maladjusted laser beam
15 Incorrect target
16 Monitoring device
17 Adjusting device
18 Sensitivity curves
19 Compensation range
20 Displacement
21 Flowchart
S1-S5 Method steps

1. A method for operating a laser system, the method comprising:
continuously monitoring maladjustments during normal operation of the laser system,
upon detecting a maladjustment, determining at least one operating parameter of the laser system, wherein a change to the at least one operating parameter has an effect counter to the maladjustment, and
adjusting the at least one operating parameter in order to compensate for the maladjustment.

2. A laser system, comprising:
at least one laser source,
an influencing device for influencing a laser beam generated by the laser source,
an optical unit disposed downstream of the laser source,
a monitoring device for detecting maladjustments of the laser system, and
a control device,
wherein the laser system is configured to carry out the method as claimed in claim 1.

3. The laser system as claimed in claim 2, wherein the laser system is configured to detect, as the maladjustments, a change in an alignment of the laser beam and/or an output caustic and/or a laser power.

4. The laser system as claimed in claim 2, wherein the influencing device comprises an amplifier for amplifying the laser beam, and the laser system is configured to determine and adjust an operating parameter of the amplifier as the at least one operating parameter.

5. The laser system as claimed in claim 2, wherein the influencing device comprises a plurality of amplifiers for amplifying the laser beam, and the laser system is configured to divide the adjusting the at least one operating parameter among the plurality of amplifiers.

6. The laser system as claimed in claim 2, wherein the operating parameter is or controls a property of the laser system that differs from a mechanical position of an optical element impinged on by the laser beam.

7. The laser system as claimed in claim 2, wherein the laser system is configured to determine the at least one operating parameter from at least one of: a gas composition, a gas temperature, a gas pressure, a gas volume flow, a gas exchange waiting time, a coolant temperature, a coolant volume flow, an RF power, an amplifier off time, or a pre-pulse laser power.

8. The laser system as claimed in claim 2, wherein the laser system is configured to limit the adjusting the at least one operating parameter such that a predetermined threshold value for a laser output power is not undershot.

9. The laser system as claimed in claim 2, wherein the laser system is configured to adjust a plurality of operating parameters in combination with one another in order to compensate for the maladjustment.

10. The laser system as claimed in claim 2, wherein the laser system is configured to adjust the at least one operating parameter by using a closed-loop control based on a model.

11. The laser system as claimed in claim 10, wherein the model is based on operating data recorded during previous operation of the laser system.

12. The laser system as claimed in claim 2, further comprising:
an adjusting device for adjusting an alignment of at least one element of the optical unit, wherein the adjusting device is configured to adjust the alignment to compensate for the maladjustment additionally or alternatively to the adjusting the at least one parameter, if and only if the maladjustment is incapable of being completely compensated for by maximum adjustment of the at least one operating parameter.
